(19) United States
(12) Patent Application Publication
(10) Pub. No.: US 2022/0145664 A1
(43) Pub. Date: May 12, 2022

(54) "Integrator" adapter for a Mul-T-Lock Deadbolt door lock and a Medeco Deadbolt door lock with an August WiFi Smart Lock/Smart Lock Pro.

(71) Applicant: Yevgeny Dobrovinsky, Brooklyn, NY (US)

(72) Inventor: Yevgeny Dobrovinsky, Brooklyn, NY (US)

(21) Appl. No.: 17/096,504

(22) Filed: Nov. 12, 2020

(51) Int. Cl. E05B 47/00

(52) U.S. Cl. CPC E05B 47/0012; E05B 2047/0095

(57) ABSTRACT

“Integrator” is a newly developed device which allows the August WiFi Smart Lock/Smart Lock Pro to operate (open/close) any Mul-T-Lock Deadbolt door lock and any Medeco Deadbolt door lock. The “Integrator” utilizes all original parts packaged with Mul-T-Lock deadbolt locks, with Medeco deadbolt locks and with August WiFi Smart Lock/Smart Lock Pro. The “Integrator” merges together during the assembly/installation of a deadbolt lock and a smart lock utilizing a “Blue” or a “Yellow/Ivory” adapter which comes pre-packaged with August WiFi Smart Lock/Smart Lock Pro.

With the “Integrator”, August WiFi Smart Lock/Smart Lock Pro works perfectly with any Mul-T-Locks deadbolt lock and any Medeco deadbolt lock. All locks operated with a key, manually, or with the August App, precisely operate the deadbolt of the lock and send out status data to the app about the deadbolts state (locked or unlocked) and the name of the user with a digital key that performed the operation. This is a perfect way to have total control of your home and safety of your loved ones.

Compatible with August lock models: ASL-02, ASL-03, ASL-03B, ASL-05 & future models.

Compatible with any current or future Mul-T-Lock deadbolt lock and any current or future Medeco deadbolt lock.

### DESCRIPTION OF THE DRAWINGS

FIG. 1: Right side of the “Integrator” showing its cylindrical part (white), flat tail part (shaded with forward & backward slashes) and a cutout (shaded with forward slashes).

FIG. 2: Top side of the “Integrator” showing its cylindrical part (white) and two cutouts opposite to each other.

FIG. 3: Bottom side of the “Integrator” showing its flat tail part (shaded with forward and backward slashes) and rear side of the cylindrical part (white).

FIG. 4: Left side of the “Integrator” showing its cylindrical part (white), flat tail part (shaded with forward & backward slashes) and a cutout (shaded with forward slashes).

FIG. 5: Right side view front the top showing “Integrators” cylindrical pan (white), flat tail part (shaded with forward & backward slashes) anc a cutout (shaded with forward slashes),

FIG. 6: Left side view from the top showing “Integrators” cylindrical part (white), flat tail pan (shaded with forward & backward slashes) and a cutout (shaded with forward slashes).

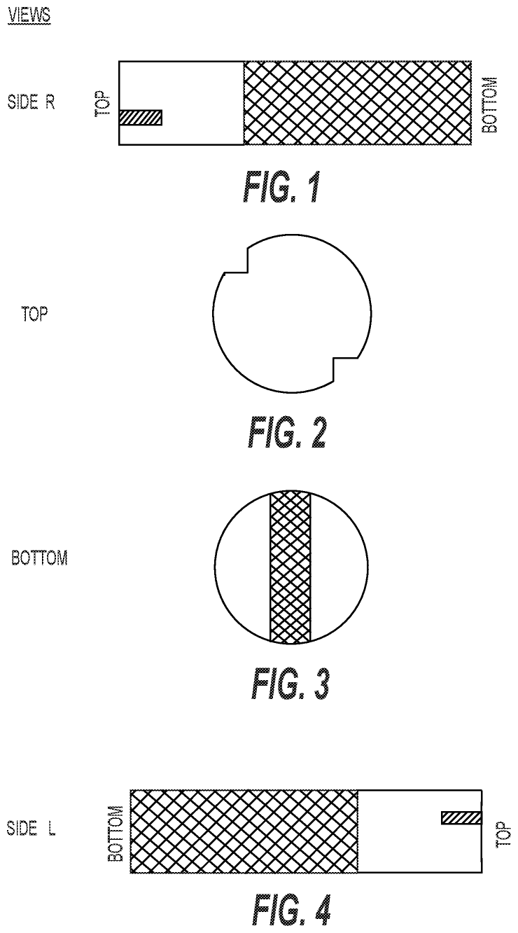

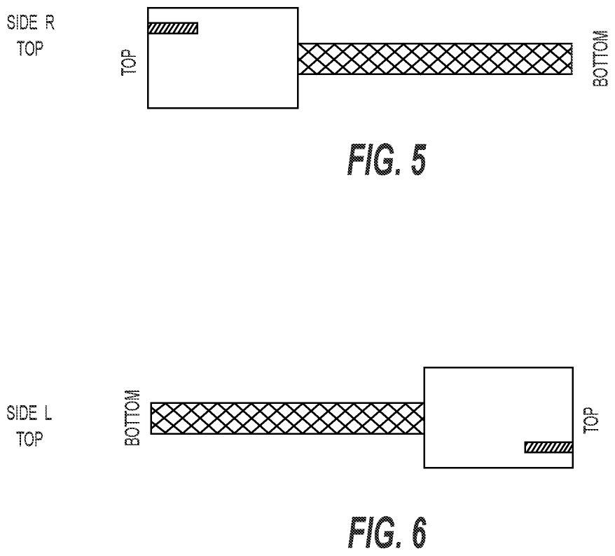

1. Until the “Integrator” adapter was invented the integration and operation of any Mul-T-Lock Deadbolt door lock and any Medeco Deadbolt door lock was not possible with an August WiFi Smart Lock/Smart Lock Pro. Incompatibility of Mul-T-Lock Deadbolt locks and Medeco Deadbolt locks with August WiFi Smart Lock/Smart Lock Pro is confirmed by August Inc (the manufacturer of the August WiFi Smart Lock/Smart Lock Pro). At present time Mul-T-Lock Deadbolt locks and Medeco Deadbolt locks are listed as not-compatible locks to work with August WiFi Smart Lock/Smart Lock Pro on the manufacturers website at August.com.
